(19) United States
(12) Patent Application Publication
(10) Pub. No.: US 2024/0217366 A1
(43) Pub. Date: Jul. 4, 2024

(54) BATTERY PACK BALANCING FOR MULTIPLE BATTERY PACK SYSTEMS USING ACTIVE LOAD MANAGEMENT

(71) Applicant: GM GLOBAL TECHNOLOGY OPERATIONS LLC, DETROIT, MI (US)

(72) Inventors: Ibrahim Haskara, Macomb, MI (US); Venkata Prasad Atluri, Novi, MI (US); Norman K. Bucknor, Troy, MI (US); Chandra S. Namuduri, Troy, MI (US); Suresh Gopalakrishnan, Troy, MI (US)

(21) Appl. No.: 18/149,870

(22) Filed: Jan. 4, 2023

(51) Int. Cl. B60L 53/62; B60L 50/60; H02J 7/00

(52) U.S. Cl. CPC B60L 53/62; B60L 50/60; H02J 7/0014; H02J 7/0048; B60L 2240/545; B60L 2240/547

(57) ABSTRACT

A method for charging an electric vehicle is provided. Aspects include configuring a switchable battery of the electric vehicle in a fast-charging configuration by connecting a first battery pack of the switchable battery to a first charging source and a second battery pack of the switchable battery to a second charging source and obtaining one or more characteristics of the first battery pack and the second battery pack. Aspects also include identifying the first battery pack as a master pack and the second battery pack as a follower pack based on a determination that the first battery pack has a lower voltage level than the second battery pack. Aspects further include adjusting a duty cycle of a switchable active load connected in parallel to the follower pack based on the one or more characteristics of the first battery pack and the second battery pack.

### INTRODUCTION

The disclosure relates to electric vehicles, and more particularly to battery pack balancing for multiple battery pack systems using active load management.

Electric vehicles (EVs) such as battery electric vehicles (BEVs), hybrid vehicles, and/or fuel cell vehicles include one or more electric machines and a battery system. The battery system includes one or more battery cells, modules, and/or packs that are connected in series and/or parallel. A power control system is used to control the charging and/or discharging of the battery system during charging and/or driving. During use, the electric machine is operated as a motor for propulsion and as a generator for regeneration during braking.

### SUMMARY

In one exemplary embodiment, an electric vehicle charging system is provided. The electric vehicle charging system includes a switchable battery including a first battery pack and a second battery pack that are selectively arranged in one of a fast-charging configuration and a drive configuration, wherein the fast-charging configuration includes connecting the first battery pack and the second battery pack to separate charging sources and the drive configuration includes connecting the first battery pack and the second battery pack in parallel. The electric vehicle charging system also includes a plurality of sensors configured to measure one or more characteristics of the first battery pack and the second battery pack, a first switchable active load connected in parallel with the first battery pack, and a second switchable active load connected in parallel with the second battery pack. The electric vehicle charging system further includes a controller configured to configure the switchable battery and activate at least one of the first switchable active load and the second switchable active load based on the one or more characteristics of the first battery pack and the second battery pack. The activation is configured to balance at least one of the one or more characteristics to the first battery pack and the second battery pack.

In addition to the one or more features described herein, the one or more characteristics includes one or more of an open circuit voltage, a state-of-charge, a terminal voltage, a temperature, and an input current level.

In addition to the one or more features described herein, the controller is further configured to identify a first battery pack as a master pack based on a determination that the first battery pack has a lower voltage level than the second battery pack.

In addition to the one or more features described herein, activating the at least one of the first switchable active load and the second switchable active load includes only activating the second switchable active load.

In addition to the one or more features described herein, the identification of the master pack is performed periodically during charging of the switchable battery.

In addition to the one or more features described herein, the controller is configured to only activate the at least one of the first switchable active load and the second switchable active load based on a determination that a state-of-charge of at least one of the first battery pack and the second battery pack is above a threshold minimum.

In addition to the one or more features described herein, the controller is further configured to monitor the one or more characteristics of the first battery pack and the second battery pack, identify an anomaly with one of first battery pack, the second battery pack, and a charging source for one of the first battery pack the second battery pack, and perform a mitigation action based on the anomaly.

In one exemplary embodiment, a method for charging an electric vehicle is provided. The method includes configuring a switchable battery of the electric vehicle in a fast-charging configuration by connecting a first battery pack of the switchable battery to a first charging source and a second battery pack of the switchable battery to a second charging source. The method also includes obtaining one or more characteristics of the first battery pack and the second battery pack and identifying the first battery pack as a master pack and the second battery pack as a follower pack based on a determination that the first battery pack has a lower voltage level than the second battery pack. The method further includes adjusting a duty cycle of a switchable active load connected in parallel to the follower pack based on the one or more characteristics of the first battery pack and the second battery pack, wherein the adjustment of the duty cycle is configured to balance at least one of the one or more characteristics to the first battery pack and the second battery pack.

In addition to the one or more features described herein, the one or more characteristics includes one or more of an open circuit voltage, a state-of-charge, a temperature, a terminal voltage, and an input current level.

In addition to the one or more features described herein, the identification of the master pack is performed periodically during charging of the switchable battery.

In addition to the one or more features described herein, the identifying the first battery pack as the master pack and adjusting the duty cycle of the switchable active load are only performed based on a determination that a state-of-charge of at least one of the first battery pack and the second battery pack is above a threshold minimum.

In addition to the one or more features described herein, the switchable active load includes a plurality of individually controllable active loads connected in parallel.

In addition to the one or more features described herein, the method also includes activating one or more of the plurality of individually controllable active loads based on a voltage imbalance between the first battery pack and the second battery pack and a power rating of each of the one or more of the plurality of individually controllable active loads.

In addition to the one or more features described herein, based at least in part on a determination that a first voltage level of the first battery pack is within a threshold range of a second voltage level of the second battery pack, the method includes configuring the switchable battery of the electric vehicle in a drive configuration by connecting the first battery pack of the switchable battery and the second battery pack in parallel and based at least in part on a determination that the first voltage level of the first battery pack is not within the threshold range of the second voltage level of the second battery pack, the method includes preventing the switchable battery of the electric vehicle from being configured in the drive configuration and activating the switchable active load to reduce a voltage level of the follower pack.

In one exemplary embodiment, an electric vehicle is provided. The electric vehicle includes a first charging source, a second charging source, and a switchable battery including a first battery pack and a second battery pack that are selectively arranged in one of a fast-charging configuration and a drive configuration, wherein the fast-charging configuration includes connecting the first battery pack to the first charging source and the second battery pack the second charging source and the drive configuration includes connecting the first battery pack and the second battery pack in parallel. The electric vehicle also includes a plurality of sensors configured to measure one or more characteristics of the first battery pack and the second battery pack, a first switchable active load connected in parallel with the first battery pack, and a second switchable active load connected in parallel with the second battery pack. The electric vehicle also includes a controller configured to configure the switchable battery and activate at least one of the first switchable active load and the second switchable active load based on the one or more characteristics of the first battery pack and the second battery pack. The activation is configured to balance at least one of the one or more characteristics to the first battery pack and the second battery pack.

In addition to the one or more features described herein, the one or more characteristics includes one or more of an open circuit voltage, a state-of-charge, a terminal voltage, a temperature, and an input current level.

In addition to the one or more features described herein, the controller is further configured to identify a first battery pack as a master pack based on a determination that the first battery pack has a lower voltage level than the second battery pack.

In addition to the one or more features described herein, activating the at least one of the first switchable active load and the second switchable active load includes only activating the second switchable active load.

In addition to the one or more features described herein, the identification of the master pack is performed periodically during charging of the switchable battery.

In addition to the one or more features described herein, the controller is configured to only activate the at least one of the first switchable active load and the second switchable active load based on a determination that a state-of-charge of at least one of the first battery pack and the second battery pack is above a threshold minimum.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a block diagram illustrating a charging system of an electric vehicle in accordance with an exemplary embodiment;

FIG. 3 is a flowchart illustrating a method for charging an electric vehicle in accordance with an exemplary embodiment;

FIG. 4 is a block diagram illustrating a portion of a charging system of an electric vehicle using active load management in accordance with an exemplary embodiment;

FIG. 5 is a schematic diagram illustrating a system for balancing the charge of battery packs of an electric vehicle using active load management and thermal controls in accordance with an exemplary embodiment; and

FIG. 6 is a flowchart illustrating a method for identifying an anomaly in a charging system of an electric vehicle in accordance with an exemplary embodiment.

### DETAILED DESCRIPTION

The following description is merely exemplary in nature and is not intended to limit the present disclosure, its application or uses.

Electric vehicles (EVs) such as battery electric vehicles (BEVs), hybrid vehicles, and/or fuel cell vehicles include one or more electric machines and a battery system. A power control system is used to control the charging and/or discharging of the battery system. In exemplary embodiments, the battery system includes a switchable battery that includes multiple battery packs that are capable of being selectively connected to each other in parallel. The multiple battery packs can also be selectively isolated from each other and separately connected to different charging sources. A power control system can be used to control the switching between the two or more configurations. For example, in a drive mode the power control system configures the multiple battery packs in parallel with each other and in a fast-charging mode the power control system separately connects each of the multiple battery packs to different charging sources.

One drawback of independently charging the battery packs of a switchable battery is that the voltage level of the battery packs will not be equal throughout the charging process and at the end of the charging process. As a result, when the battery packs of the switchable battery are re-connected to each other in parallel, the battery packs with lower voltage levels will experience an inrush of current that can damage the battery pack. The methods and systems disclosed herein provide for charging a switchable battery pack of an electric vehicle using active load management to ensure that the voltages of the battery packs remain within a threshold level of each other throughout the charging process.

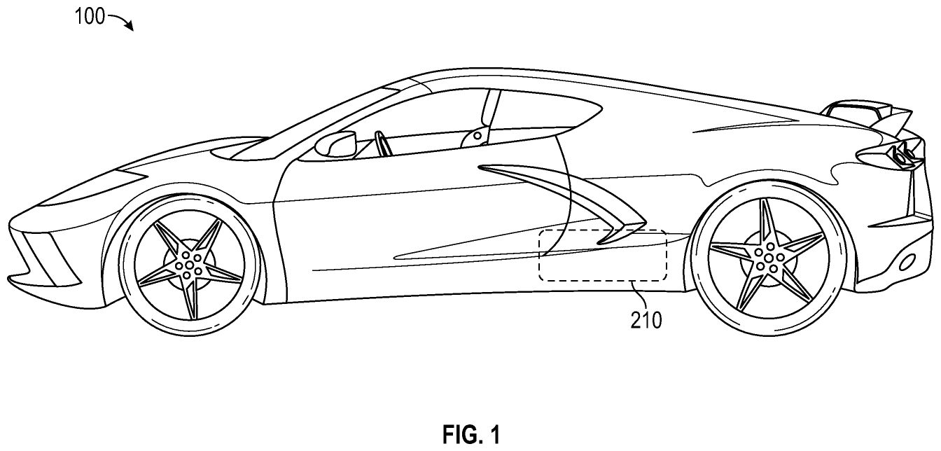

Referring now to FIG. 1, a schematic diagram of a vehicle 100 for use in conjunction with one or more embodiments of the present disclosure is shown. The vehicle 100 includes a switchable battery 210. In one embodiment, the vehicle 100 is a hybrid vehicle that utilizes both an internal combustion engine and an electric motor powered by the switchable battery. In another embodiment, the vehicle 100 is an electric vehicle that only utilizes electric motors that are powered by the switchable battery.

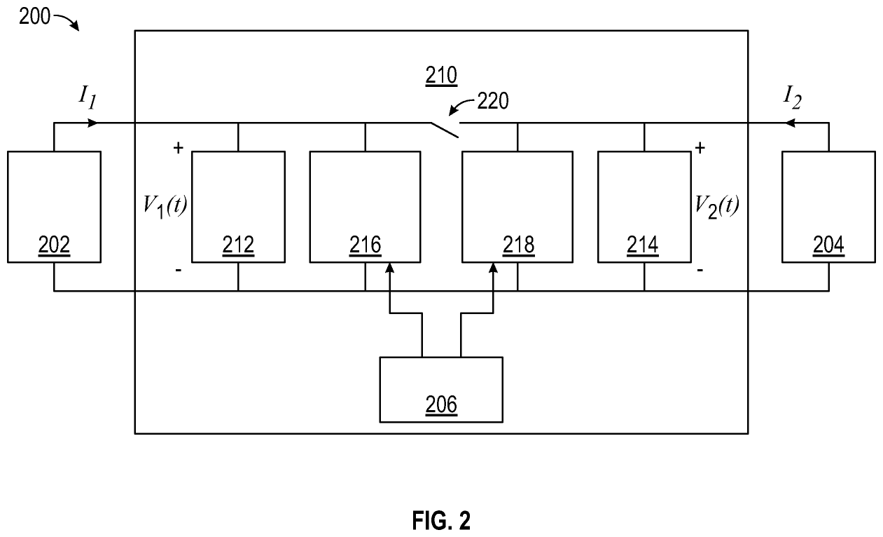

FIG. 2 is a block diagram illustrating a charging system 200 of an electric vehicle in accordance with an exemplary embodiment. The charging system 200 includes a first charging source 202, a second charging source 204, a controller 206, and a switchable battery 210. In exemplary embodiments, the switchable battery 210 includes a first battery pack 212 and a second battery pack 214 that can be selectively connected to each other in parallel or isolated from one another via switch 220. In one embodiment, the operation of the switch 220 is controlled by the controller 206.

In exemplary embodiments, the controller 206 is configured to utilize one or more sensors to monitor a first voltage level (V₁) of the first battery pack 212 and a second voltage level (V₂) of the second battery pack 214. The controller 206 may also monitor other characteristics of the first battery pack 212 and the second battery pack 214, which include one or more of an open circuit voltage, a state-of-charge, a temperature, and an input current level. In exemplary embodiments, the controller 206 designates one of the first battery pack 212 and the second battery pack 214 as a master pack. In one embodiment, the battery pack with the lowest voltage level is designated as the master pack and the other battery pack(s) are designated as follower packs.

In exemplary embodiments, during a fast-charging mode, the switch 220 is in an open configuration to, at least partially, isolate the first battery pack 212 from the second battery pack 214. The first charging source 202 is configured to provide a first charging current (I₁) and the second charging source is configured to provide a second charging current (I₂). In exemplary embodiments, the controller 206 deactivates the switchable active load associated with the master pack and activates and controls the operation of the switchable active load associated with the follower packs. In general, the controller 206 activates the switchable active loads with the follower packs to reduce the current supplied to the follower packs to balance the voltage level of the master pack and the follower packs.

In one example, the first battery pack 212 has a lower voltage level (V₁) than the voltage level (V₂) of the second battery pack 214 and is therefore designated as the master pack by the controller 206. In general, once the first battery pack 212 is designated as the master pack, the controller 206 deactivates the first switchable active load 216 and the first charging current (11) is applied to the first battery pack 212. In some cases, the first switchable active load 216 may remain active and a portion of the charging current (I₁) is applied to the pack. In other embodiments, the controller 206 deactivates the first switchable active load 216 and the charging current is applied to the first battery pack 212. In addition, the controller 206 is configured to calculate the difference between the voltage level (V₂) and the lower voltage level (V₁) and to responsively activate and control the second switchable active load 218. As a result, a portion of the second charging current (I₂) is applied to the second switchable active load 218 and the remaining portion of the second charging current (I₂) is applied to the second battery pack 214. In exemplary embodiments, the controller 206 is configured to control a level of current applied to the second battery pack 214 selectively activating different loads within the second switchable active load 218 and optionally controlling a duty cycle for each of the activated loads.

In exemplary embodiments, the controller 206 is configured to reduce the charging speed of battery packs designated as follower packs such that the voltage level of the master pack will increase at a faster rate than the follower packs. As a result, the voltage of the master pack will increase to approximately the same as the voltage level of the follower pack. In exemplary embodiments, the identification and designation of master and follower packs are performed at the beginning of the fast-charging process and the designations can be continually updated during the fast-charging process.

Although the switchable battery 210 is illustrated as having two battery packs and two active loads, it will be appreciated by those of ordinary skill in the art that the switchable battery 210 may include more than two battery packs and that each battery pack may have a plurality of active loads. In exemplary embodiments, each battery pack includes a plurality of active loads that have different power ratings.

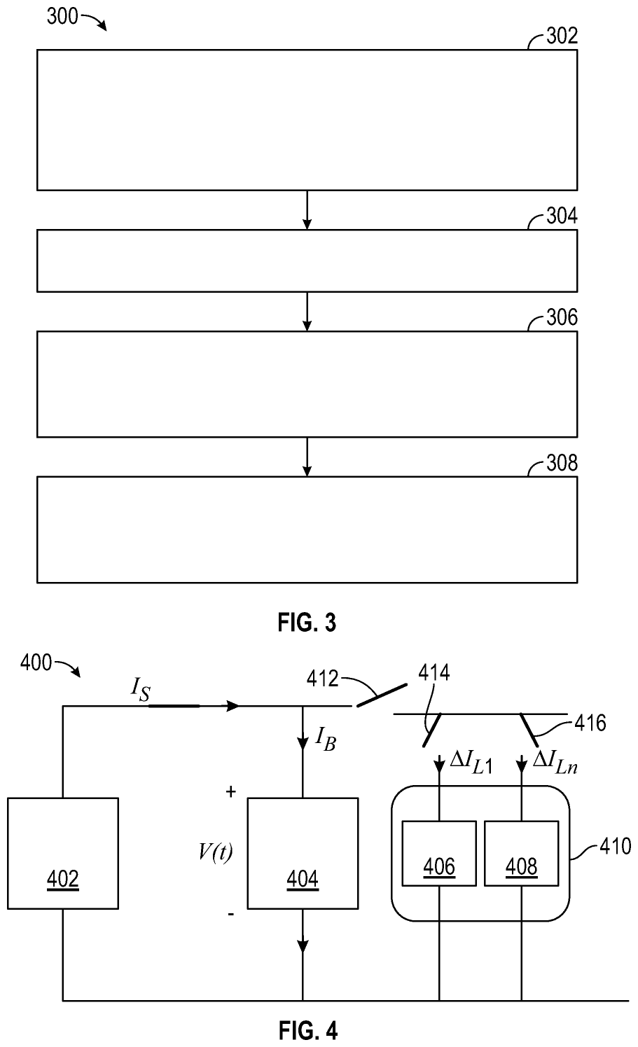

Referring now to FIG. 3 a flowchart illustrating a method 300 for charging an electric vehicle in accordance with an exemplary embodiment is shown. At block 302, the method 300 includes configuring a switchable battery of the electric vehicle in a fast-charging configuration by connecting a first battery pack of the switchable battery to a first charging source and a second battery pack of the switchable battery to a second charging source. Next, at block 304, the method 300 includes obtaining one or more characteristics of the first battery pack and the second battery pack. In exemplary embodiments, the one or more characteristics include one or more of an open circuit voltage, a state-of-charge, a temperature, a terminal voltage, and an input current level.

At block 306, the method 300 includes identifying a first battery pack as a master pack and a second battery pack as a follower pack based on a determination that the first battery pack has a lower voltage level than the second battery pack. In exemplary embodiments, the identification of the master pack is performed periodically during the charging of the switchable battery. At block 308, the method 300 includes adjusting a duty cycle of a switchable active load connected in parallel to the follower pack based on the one or more characteristics of the master battery pack and the follower battery pack. The adjustment of the duty cycle is configured to balance at least one of the one or more characteristics of the master battery pack and the follower battery pack.

In exemplary embodiments, identifying the master pack and adjusting the duty cycle of the switchable active load are only performed based on a determination that a state-of-charge of at least one of the battery packs is above a threshold minimum. For example, when the switchable battery is first configured in the fast-charging mode and connected to the first and second charging sources, the full charging current from the charging sources are applied to the first battery pack 212 and the second battery pack 214 until the state-of-charge of at least one of the battery packs is above a threshold minimum, such as seventy percent.

In exemplary embodiments, the switchable battery of the electric vehicle can be reconfigured in a drive configuration by connecting the first battery pack and the second battery pack in parallel based at least in part on a determination that a first voltage level of the first battery pack is within a threshold range of a second voltage level of the second battery pack. If the first voltage level of the first battery pack is not within the threshold range of the second voltage level of the second battery pack, the switchable battery is prevented from being reconfigured in a drive configuration and one or more of the switchable active loads are activated to reduce the voltage level of one or more of the battery pack to bring the first voltage level of the first battery pack within the threshold range of the second voltage level.

Referring now to FIG. 4, a block diagram illustrating a portion of a charging system 400 of an electric vehicle using active load management in accordance with an exemplary embodiment is shown. The charging system 400 includes a charging source 402 that is connected to a battery pack 404 and selectively connected to a switchable active load 410 via a switch 412. The switchable active load 410 includes a first load 406 and a second load 408 that can be selectively connected to the battery pack 404 via switches 414, 416 respectively. In exemplary embodiments, a controller (not shown) is configured to control the operation of switches 412, 414, and 416 in order to control the portion of the current Is supplied by the charging source 402 that is applied to the battery pack 404. In exemplary embodiments, the current Is supplied by the charging source 402 is equal to the current I_{B} supplied to the battery pack 404 plus the currents applied to the first load 406 (I_{L1}) and a second load 408 (I_{Ln}). In exemplary embodiments, the currents supplied to each of the loads are controlled by controlling a duty cycle of the switch connecting the loads to the battery pack. In exemplary embodiments, one of the loads of the switchable active load 410 is a chiller that is configured to cool the battery pack 404.

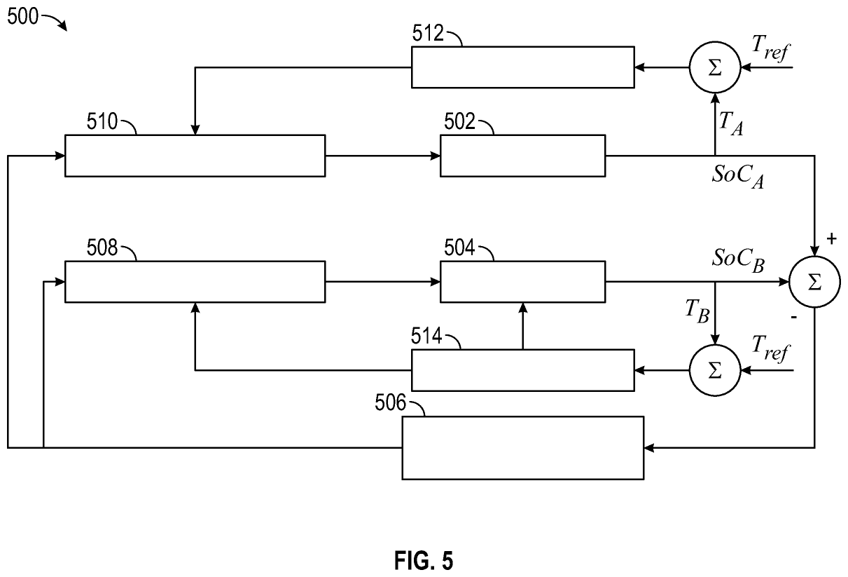

Referring now to FIG. 5, a schematic diagram of a system 500 for balancing the charge of battery packs of an electric vehicle using active load management and thermal controls in accordance with an exemplary embodiment is shown. In exemplary embodiments, battery pack A 502 and battery pack B 504 are similar battery packs that are cooled by chillers 510, 508, respectively. In addition, battery pack A 502 is the power source for chiller 510 and battery pack B 504 is the power source for chiller 508. In this embodiment, the temperatures of the battery packs (T_{A} and T_{B}) are monitored and actively controlled by pack temperature controllers 512, 514, respectively. In addition, the state-of-charge of the battery packs (SoC_{A} and SoC_{B}) are analyzed by an active load controller 506. The active load controller 506 is configured to identify any imbalance between the SoC_{A} and SoC_{B} and to instruct chillers 508, 510 to adjust their operational characteristics to balance both the SoC_{A} and SoC_{B} and T_{A} and T_{B}. For example, in one embodiment, SoC_{A} is greater than SoC_{B} and T_{A} and T_{B} are approximately equal. In this case, the active load controller 506 instructs the chiller 508 to increase the rate of flow of cooling fluid through battery pack B 504, this increase in flow requires a pump of the chiller to operate at an increased workload which will reduce SoC_{B}. Once this control is applied for balancing during independent charging, the end result of the control will be slowing the charging of follower packs. In that sense, the SoC_{B} can still be increasing, yet at a slower rate so that the SoC_{B} will catch up to SoC_{A}.

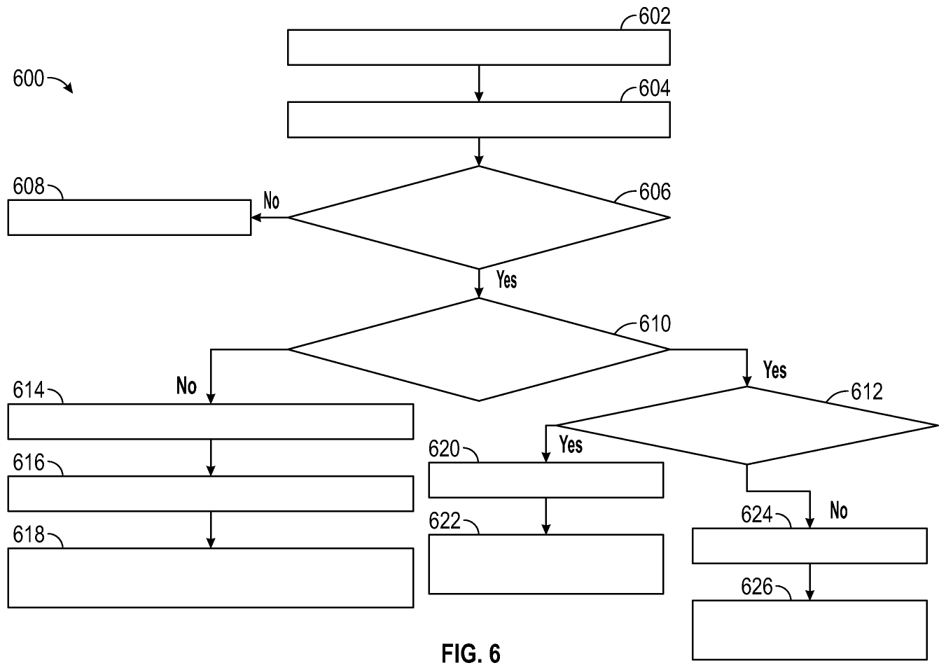

Referring now to FIG. 6, a flowchart illustrating a method 600 for identifying an anomaly in a charging system of an electric vehicle in accordance with an exemplary embodiment is shown. At block 602 the electric vehicle is requested to perform fast-charging. Next, at block 604, the electric vehicle configures the switchable battery into a fast-charging configuration. Next, at block 606, it is determined whether a voltage of a battery pack of the switchable battery is significantly different than the rest of the battery packs of the switchable battery. If all of the battery pack have voltages within a threshold range of one another, the method 600 proceeds to block 608, and no anomaly is indicated. Otherwise, the method 600 proceeds to block 610 and it is determined whether a requested charging current for the identified battery pack is within a threshold of the charging current being applied to the battery pack. If the requested charging current for the identified battery pack is not within the threshold of the charging current being applied to the battery pack, the method 600 proceeds to block 614 and an anomaly is indicated with the charger or charging port. Once an anomaly is indicated with the charger or charging port, at block 616, the method 600 removes the pack associated with the anomalous charger or charging port from the battery pack balancing algorithm. If the requested charging current for the identified battery pack is within the threshold of the charging current being applied to the battery pack, the method 600 proceeds to block 612 to check if a load balancing command exceeds a threshold level, (i.e., is abnormally high). If the load balancing command exceeds a threshold level, an anomaly with the battery pack is indicated, at block 620. Otherwise, an anomaly with the load management hardware is indicated, at block 624.

Based on an anomaly being indicated with the charger or charging port, the method 600 proceeds to block 618 and reconfigures the routing between the charging port and battery pack after other battery packs have completed charging to complete charging for the identified battery pack by a different port. Based on an anomaly being indicated with the battery pack, the method 600 proceeds to block 620 and the identified battery pack is disabled at block 622, and the drive mode is reconfigured to not use the battery pack. Based on an anomaly being indicated with the load management hardware, the method 600 proceeds to block 626, and the load management hardware is reconfigured or disabled.

In exemplary embodiments, the switchable active loads within a battery pack are selected based on the magnitude of voltage imbalance and the power ratings of the possible active loads. The control automatically calculates the voltage imbalance and determines which load(s) should be active, and at what duty cycle, based on the voltage imbalance and the stored power ratings of the switchable active loads.

In one embodiment, one or more of the switchable active loads may be selectively connected to different battery packs using one or more switches controlled by the controller. For example, the controller may activate one or more switches to connect a switchable active load to a battery pack with a higher voltage to slow its charging and upon a determination that the master pack has changed, then the same load may be switched to be connected to another battery pack.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electric vehicle charging system comprising:
a switchable battery including a first battery pack and a second battery pack that are selectively arranged in one of a fast-charging configuration and a drive configuration, wherein the fast-charging configuration includes connecting the first battery pack and the second battery pack to separate charging sources and the drive configuration includes connecting the first battery pack and the second battery pack in parallel;
a plurality of sensors configured to measure one or more characteristics of the first battery pack and the second battery pack;
a first switchable active load connected in parallel with the first battery pack;
a second switchable active load connected in parallel with the second battery pack; and
a controller configured to:
configure the switchable battery; and
activate at least one of the first switchable active load and the second switchable active load based on the one or more characteristics of the first battery pack and the second battery pack,
wherein the activation is configured to balance at least one of the one or more characteristics to the first battery pack and the second battery pack.

2. The electric vehicle charging system of claim 1, wherein the one or more characteristics includes one or more of an open circuit voltage, a state-of-charge, a terminal voltage, a temperature and an input current level.

3. The electric vehicle charging system of claim 1, wherein the controller is further configured to identify a first battery pack as a master pack based on a determination that the first battery pack has a lower voltage level than the second battery pack.

4. The electric vehicle charging system of claim 3, wherein activating the at least one of the first switchable active load and the second switchable active load includes only activating the second switchable active load.

5. The electric vehicle charging system of claim 3, wherein the identification of the master pack is performed periodically during charging of the switchable battery.

6. The electric vehicle charging system of claim 1, wherein the controller is configured to only activate the at least one of the first switchable active load and the second switchable active load based on a determination that a state-of-charge of at least one of the first battery pack and the second battery pack is above a threshold minimum.

7. The electric vehicle charging system of claim 1, wherein the controller is further configured to:
monitor the one or more characteristics of the first battery pack and the second battery pack;
identify an anomaly with one of first battery pack, the second battery pack, and a charging source for one of the first battery pack the second battery pack; and
perform a mitigation action based on the anomaly.

8. A method for charging an electric vehicle, the method comprising:
configuring a switchable battery of the electric vehicle in a fast-charging configuration by connecting a first battery pack of the switchable battery to a first charging source and a second battery pack of the switchable battery to a second charging source;
obtaining one or more characteristics of the first battery pack and the second battery pack;
identifying the first battery pack as a master pack and the second battery pack as a follower pack based on a determination that the first battery pack has a lower voltage level than the second battery pack; and
adjusting a duty cycle of a switchable active load connected in parallel to the follower pack based on the one or more characteristics of the first battery pack and the second battery pack,
wherein the adjustment of the duty cycle is configured to balance at least one of the one or more characteristics to the first battery pack and the second battery pack.

9. The method of claim 8, wherein the one or more characteristics includes one or more of an open circuit voltage, a state-of-charge, a temperature, a terminal voltage, and an input current level.

10. The method of claim 8, wherein the identification of the master pack is performed periodically during charging of the switchable battery.

11. The method of claim 8, wherein the identifying the first battery pack as the master pack and adjusting the duty cycle of the switchable active load are only performed based on a determination that a state-of-charge of at least one of the first battery pack and the second battery pack is above a threshold minimum.

12. The method of claim 8, wherein the switchable active load includes a plurality of individually controllable active loads connected in parallel.

13. The method of claim 12, further comprising activating one or more of the plurality of individually controllable active loads based on a voltage imbalance between the first battery pack and the second battery pack and a power rating of each of the one or more of the plurality of individually controllable active loads.

14. The method of claim 8, further comprising:
based at least in part on a determination that a first voltage level of the first battery pack is within a threshold range of a second voltage level of the second battery pack, configuring the switchable battery of the electric vehicle in a drive configuration by connecting the first battery pack of the switchable battery and the second battery pack in parallel; and
based at least in part on a determination that the first voltage level of the first battery pack is not within the threshold range of the second voltage level of the second battery pack, preventing the switchable battery of the electric vehicle from being configured in the drive configuration and activating the switchable active load to reduce a voltage level of the follower pack.

15. An electric vehicle, comprising:
a first charging source;
a second charging source;
a switchable battery including a first battery pack and a second battery pack that are selectively arranged in one of a fast-charging configuration and a drive configuration, wherein the fast-charging configuration includes connecting the first battery pack to the first charging source and the second battery pack the second charging source and the drive configuration includes connecting the first battery pack and the second battery pack in parallel;
a plurality of sensors configured to measure one or more characteristics of the first battery pack and the second battery pack;
a first switchable active load connected in parallel with the first battery pack;
a second switchable active load connected in parallel with the second battery pack; and
a controller configured to:
configure the switchable battery; and
activate at least one of the first switchable active load and the second switchable active load based on the one or more characteristics of the first battery pack and the second battery pack,
wherein the activation is configured to balance at least one of the one or more characteristics to the first battery pack and the second battery pack.

16. The electric vehicle of claim 15, wherein the one or more characteristics includes one or more of an open circuit voltage, a state-of-charge, a terminal voltage, a temperature and an input current level.

17. The electric vehicle of claim 15, wherein the controller is further configured to identify a first battery pack as a master pack based on a determination that the first battery pack has a lower voltage level than the second battery pack.

18. The electric vehicle of claim 17, wherein activating the at least one of the first switchable active load and the second switchable active load includes only activating the second switchable active load.

19. The electric vehicle of claim 17, wherein the identification of the master pack is performed periodically during charging of the switchable battery.

20. The electric vehicle of claim 15, wherein the controller is configured to only activate the at least one of the first switchable active load and the second switchable active load based on a determination that a state-of-charge of at least one of the first battery pack and the second battery pack is above a threshold minimum.
